(19) United States
(12) Patent Application Publication
(10) Pub. No.: US 2005/0205271 A1
(43) Pub. Date: Sep. 22, 2005

(54) Hand propelled soil cultivator apparatus

(76) Inventor: Ruben F. Prado, Balsam Grove, NC (US)

Correspondence Address: Joseph T. Guy, Ph.D.;Nexsen Pruet Adams Kleemeier, LLC, PO Drawer 10648, Greenville, SC, 29603-0648, US

(21) Appl. No.: 10/801,465

(22) Filed: Mar. 16, 2004

(51) Int. Cl. A01B 3/02

(52) U.S. Cl. 172/329

(57) ABSTRACT

A cultivator with a lower frame with a front and a rear. Two wheels are attached to the front of the lower frame. An upper frame is attached to the lower frame extending rearward. Tines are attached to the rear of the lower frame extending forward. Plow elements are attached to the tines wherein the plow elements comprise a cutting point and a cutting edge.

### BACKGROUND OF THE INVENTION

The present invention is directed to an apparatus for cultivating soil. More specifically, the present invention is directed to a hand propelled apparatus for cultivating soil efficiently and easily.

The desire to plant and harvest crops extends over many centuries. This activity extends from large farms utilizing motorized equipment to small home plots with but a few plants. In either case it is always the desire to improve efficiency, particularly, with regards to elimination of non-edible plants such as weeds, grass and the like.

Small home plots are typically maintained by hand due to the high cost of motorized equipment and the difficulty associated with operating such equipment in small areas. Hand operated rakes and hoes are commonly employed regardless of the difficulty associated with such use. Particularly, hoes and rakes are difficult on the back and arms since they have to be constantly lifted, forced down into the soil and pulled.

Hand operated wheeled cultivating tools have been known for some time. Each of these is an attempt to alleviate the deficiencies of rakes and hoes. Single wheeled cultivators, such as described in U.S. Pat. Nos. 4,090,457; 4,168,749 and 4,854,391 are difficult to operate since the operator has to push forward while also maintaining the apparatus in proper position from side to side. When these devices are propelled forward the engagement with the ground typically causes the apparatus to tilt to one side or the other thereby causing the operator to exert more pressure to one side. This uneven pressure tends to force the apparatus to turn which is undesirable since the purpose of such devices is to operate in a small area.

Two wheeled tools are preferred as exemplified in U.S. Pat. Nos. 5,983,616 and 2,953,210. The tool described in U.S. Pat. No. 5,983,616 is designed specifically for pulling which is difficult to do. The tool has two modes. One mode has a wide bar which is pulled under the soil. If a rock, or buried stick, is encountered this device proves to be difficult to use. The other mode comprises tines which cut streaks in the soil. A weed which is between the tines is undisturbed thereby requiring multiple passes to insure that a tine is aligned with each weed for full eradication of the weeds. Furthermore, the depth of the tines is limited by the wheels.

The tool described in U.S. Pat. No. 2,953,210 comprises tines which are perpendicular to the soil. The tines scratch the soil but there is no turning of the soil as desired to adequately remove weeds. The depth of cut is also undesirably limited by the wheels.

The prior art lacks an adequate cultivator which allows ease of operation without the necessity to control the tool from side to side; removes weeds and unwanted vegetation without multiple passes; allows for variable depth; turns the soil instead of just separating or scratching and which is light weight and durable. Such a cultivator is provided by the present invention.

### SUMMARY OF THE INVENTION

It is an object of the present invention to provide a hand propelled cultivator particularly suitable for cultivating soil in a small area.

It is another object of the present invention to provide a cultivator which removes weeds and unwanted vegetation and turns the surface of the soil to foster water uptake and prohibit weeds from returning.

It is another object of the present invention to provide a cultivator which can cultivate at various depths without the need for alterations or adjustments in the tool.

A particular feature of the present invention is the simplicity of design and the location of the tines rearward of the wheels thereby insuring that the majority of force is applied to the tines instead of to the wheels.

A particular feature of the present invention is the ease of operation without necessity for multiple passages over an area of soil.

These and other advantages, as will be realized, are provided in a cultivator. The cultivator has a lower frame with a front and a rear. Two wheels are attached to the front of the lower frame. An upper frame is attached to the lower frame extending rearward. Tines are attached to the rear of the lower frame extending forward. Plow elements are attached to the tines wherein the plow elements comprise a cutting point and a cutting edge.

Yet another embodiment is provided in a cultivator comprising a lower frame with a front and a rear. The lower support frame elements extend from the front to the rear. A cross brace is attached to the lower support frame elements. Two wheels are attached to the lower support frame elements. An upper frame is attached to the front of the lower frame extending rearward. J shaped tines are attached to the cross brace with a shorter portion of the tines extending forward. Plow elements are attached to the tines wherein the plow elements comprise a cutting point and a cutting edge wherein the cutting edge is at an angle of about 25° to about 75° with respect to a soil surface.

Yet another embodiment is provided in a cultivator comprising a lower frame with a front and a rear. The lower frame has lower support frame elements extending from the front to the rear; and a cross brace attached to the lower support frame elements. Two wheels attached to the lower support frame elements. An upper frame is attached to the front of the lower frame extending rearward. J shaped tines are attached to the cross brace with a shorter portion of the tines extending forward. The tines are in two rows and the tines in a first row are staggered with respect to the tines in a second row. Plow elements attached to the tines wherein the plow elements comprise a cutting point and a cutting edge. The cutting edge is at an angle of about 25° to about 75° with respect to a soil surface.

### DESCRIPTION OF THE DRAWINGS

FIG. 1 is a front perspective view of a cultivator of the present invention.

FIG. 2 is a side view of the cultivator of the present invention.

FIG. 3 is a front view of the cultivator of the present invention.

FIG. 4 is a rear view of the cultivator of the present invention.

### DETAILED DESCRIPTION OF THE INVENTION

The invention will be described with respect to the drawings which form an integral part of the disclosure but which do not limit the disclosure. In the various drawings similar elements will be numbered accordingly.

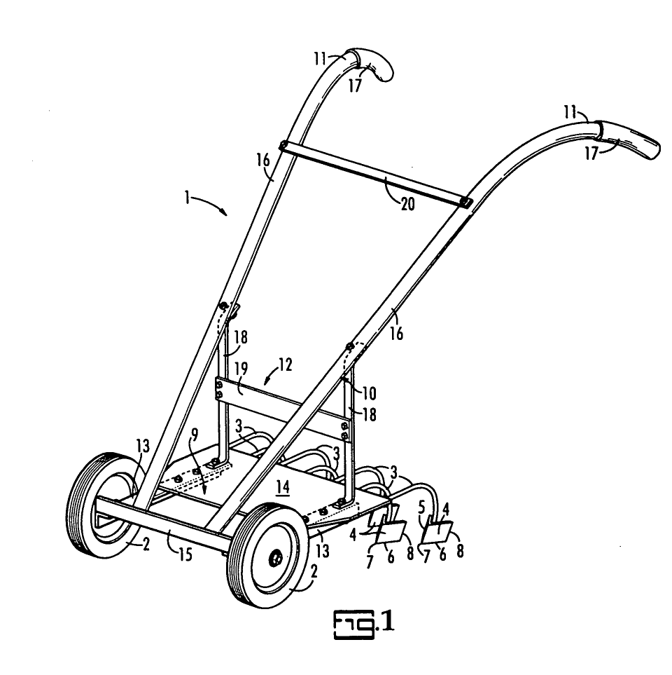

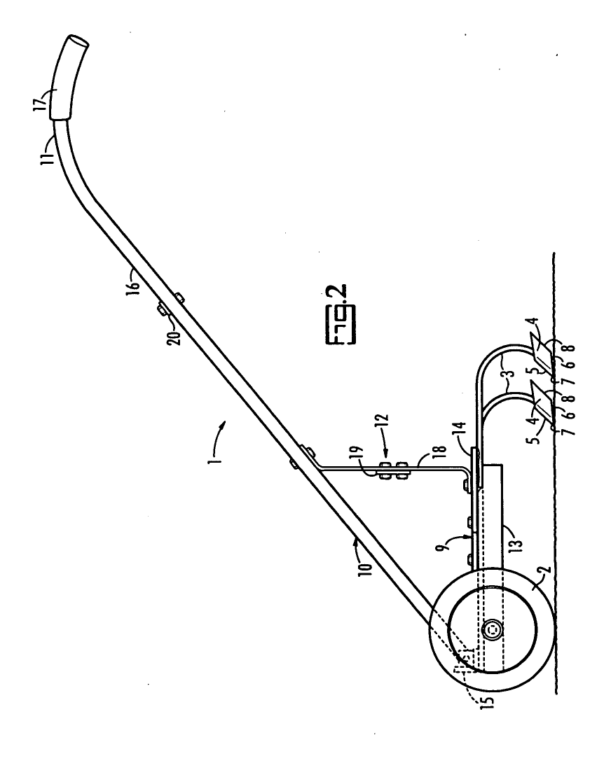

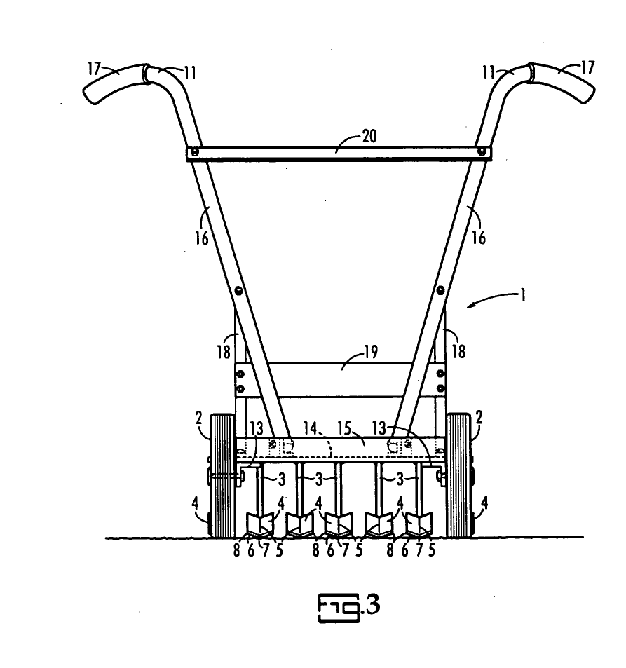

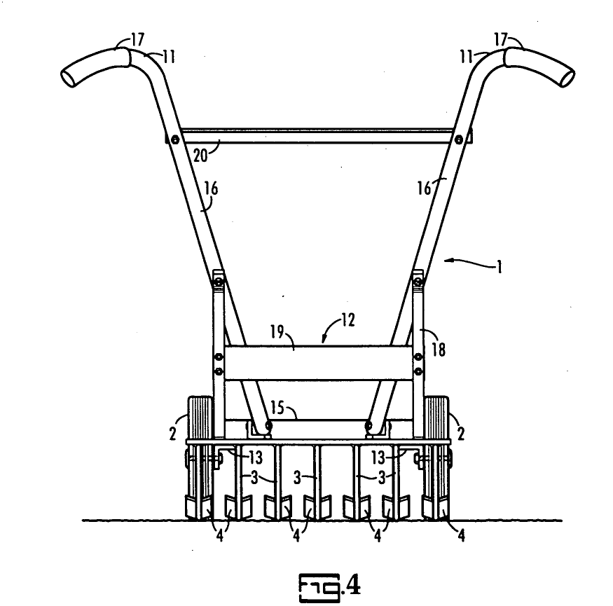

The cultivator, 1, is shown in perspective view in FIG. 1, in side view in FIG. 2, in front view in FIG. 3 and rear view in FIG. 4.

The cultivator, 1, comprises a pair of wheels, 2, which are preferably parallel with a common axis of rotation. Between the wheels, 2, is a frame the various parts of which will be described in detail herein. Attached to the lower portion of the frame are a multiplicity of tines, 3, preferably in staggered offset relationship. The tines are preferably “J” shaped with the lower portion of the tine pointing forward towards the wheels. Attached to the lower portion of the tines, 3, is a trigonal plow element, 4, which forms a point directed substantially forward. The combination of forward directed tines and forward directed plow elemens causes the soil to be lifted and rolled to each side thereby increasing the surface area disturbed with each passage of the cultivator.

The plow element, 4, preferably comprises a cutting edge, 5, which forms an angle of at least about 25° to no more than about 75° with the surface of the soil. If the angle is to small the soil lifting characteristics are compromised and if the angle is to large the ability to roll the soil is compromised. It is most preferred that the cutting edge form an angle of about 30-60° with the soil.

The lower edge, 6, of the plow element, 4, is preferably about planar with the soil and more specifically at an angle of less than about 20° with respect to the surface of the soil. It is most preferable that the trailing end, 8, of the plow element be slightly above the lower point, 7, of the cutting edge, 5, If the trailing end, 8, of the plow element, 4, is below the lower point, 7, of the cutting edge, 5, the trailing end, 8, causes an unproductive drag which is undesirable. If the trailing edge is to far above the cutting edge the ability to roll the soil is compromised.

The frame comprises a lower portion, 9, which is substantially parallel to the soil surface and extended rearward to provide an attachment point for the tines. The frame further comprises an upper portion, 10, which terminates in handles, 11. A stabilizer span, 12, is preferably incorporated between the lower portion and upper portion for strength.

The lower frame, 9, preferably comprises a pair of lower support frame elements, 13, to which the wheels, 2, are attached in any manner known in the art for attaching wheels to a frame. The lower support frame elements, 13, extend rearward and are preferably connected to a cross-brace, 14. The tines, 3, are preferably attached to the cross-brace, 14. A front cross brace, 15, is also preferred for strength.

The upper portion, 10, of the frame preferably comprises a pair of extensions, 16, which project upward towards the rear and terminate rearward of the tines at a handle, 11. A grip, 17, on the handle is preferable.

The stabilizer span, 12, preferably comprises an upright brace, 18, on either side between each extension, 16, and the lower frame, 9. A cross-brace, 19, between the upright braces, 18, is preferred. An upper cross-brace, 20, is preferred for stability.

It is preferred that the tines are aligned in two rows with the forward tines aligned between the rearward tines in a staggered offset configuration. The staggered offset configuration insures that the entire span of soil between the wheels is disturbed with each pass of the cultivator. It is most preferred that there be more rearward tines than forward tines since, with untilled soil, the fewer number of front tines can be pushed through unbroken soil with the larger number of tines following to further break up the soil turned by the front tines. The number of tines is based on the width of the device but three forward and four rearward tines has proven to be optimal for a device of approximately 18 inches wide. A narrower cultivator would require fewer tines and a wider cultivator would require more tines. The preferred separation between tines is about 3 to about 6 inches.

It is most preferred that the tines be arranged such that the cutting points are all substantially in a common plane and the plane is slightly below the soil surface at normal pushing height. This configuration provides optimum operation at minimal operator effort.

A particular feature of the present invention is the location of the tines rearward of the wheels. By lifting, or lowering, the handles the operator can raise or lower the tines relative to the surface of the soil. This allows the depth of cut to be adjusted without alteration of the cultivator in any way.

The width of the cultivator is preferably at least about 12 inches to no more than about 30 inches. Below about 12 inches the cultivator requires multiple passes to do a small area. Above about 30 inches the force required to push the cultivator becomes detrimental and the width between rows is larger than desired in many instances.

The invention has been describes with particular emphasis on the preferred embodiments. It would be apparent that other configurations and alterations could be enlisted without deviating from the scope of the invention which is set forth in the claims appended hereto.

1-10. (canceled)

11. A cultivator comprising:
a lower frame with a front and a rear comprising:
lower support frame elements extending from said front to said rear; and
a cross brace attached to said lower support frame elements;
two wheels attached to said lower support frame elements;
an upper frame attached to said front of said lower frame and extending rearward;
J shaped tines attached to said cross brace with a shorter portion of said tines extending forward and between said wheels;
two plow elements attached to said tines wherein said plow elements comprise a cutting point and meet at a cutting edge wherein said cutting edge is at an angle of about 25° to about 75° with respect to a soil surface.

12. The cultivator of claim 11 wherein said tines are in two rows.

13. The cultivator of claim 12 wherein said tines in a first row are staggered with respect to said tines in a second row.

14. The cultivator of claim 13 comprising three tines in said first row and four tines in said second row.

15. A cultivator comprising:
a lower frame with a front and a rear comprising:
lower support frame elements extending from said front to said rear; and
a cross brace attached to said lower support frame elements;
two wheels attached to said lower support frame elements;
an upper frame attached to said front of said lower frame and extending rearward and between said wheels;
J shaped tines attached to said cross brace with a shorter portion of said tines extending forward and wherein said tines are in two rows and wherein said tines in a first row are staggered with respect to said tines in a second row;
two plow elements attached to said tines wherein said plow elements comprise a cutting point and meet at a cutting edge wherein said cutting edge is at an angle of about 25° to about 75° with respect to a soil surface.
